(19) United States
(12) Patent Application Publication
(10) Pub. No.: US 2025/0332601 A1
(43) Pub. Date: Oct. 30, 2025

(54) SHAFT LOCKING MECHANISM AND SYSTEM FOR A ROTARY ATOMIZER

(71) Applicants: A B DEV LTD., Dorset (GB); Carlisle Fluid Technologies, LLC, Scottsdale, AZ (US)

(72) Inventors: Rodney Nichols, Orland, IN (US); Max George Knight, Dorset (GB); Benjamin Szirony, Toledo, OH (US); Richard Broom, Dorset (GB)

(21) Appl. No.: 19/259,647

(22) Filed: Jul. 3, 2025

Related U.S. Application Data
(63) Continuation of application No. PCT/US2024/010488, filed on Jan. 5, 2024.
(60) Provisional application No. 63/437,269, filed on Jan. 5, 2023.

(51) Int. Cl. B05B 3/02

(52) U.S. Cl. CPC B05B 3/02

(57) ABSTRACT

A locking mechanism for a rotatable shaft can include a locking pin comprising a locking pin shaft side and locking pin spindle side, a compressed air supply port in fluid communication with a compressed air supply, and a spring, wherein the spring is configured to place the locking pin spindle side in direct mechanical communication with the compressed air supply port when the compressed air supply is not activated.

### BACKGROUND

Disclosed is an apparatus, and specifically, a shaft locking mechanism for a rotary atomizer.

### SUMMARY

A rotary atomizer can include an applicator attached to a distal end of a shaft, wherein the shaft comprises at least one recess configured to receive a locking pin.

A system can include a coating supply, a compressed air supply, and a rotary atomizer in fluid communication with the coating source and the compressed air source, wherein the rotary atomizer comprises a shaft lock mechanism.

A locking mechanism for a rotatable shaft can include a locking pin comprising a locking pin shaft side and locking pin spindle side, a compressed air supply port in fluid communication with a compressed air supply, and a spring, wherein the spring is configured to place the locking pin spindle side in direct mechanical communication with the compressed air supply port when the compressed air supply is not activated.

### BRIEF DESCRIPTION OF THE FIGURES

FIG. 1 is an example, non-limiting cutaway view of the rotary atomizer disclosed herein.

FIG. 2 is an example, non-limiting cutaway view of the locking mechanism disclosed herein.

FIG. 3 is an example, non-limiting diagram of the system disclosed herein.

### DETAILED DESCRIPTION

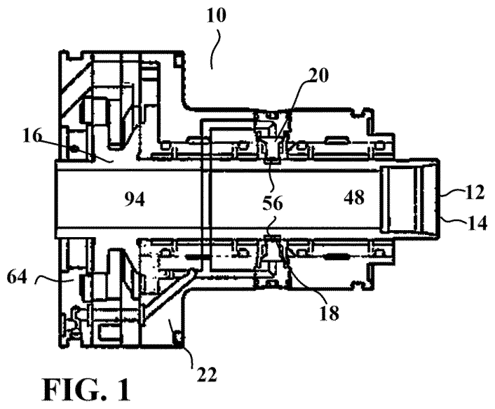

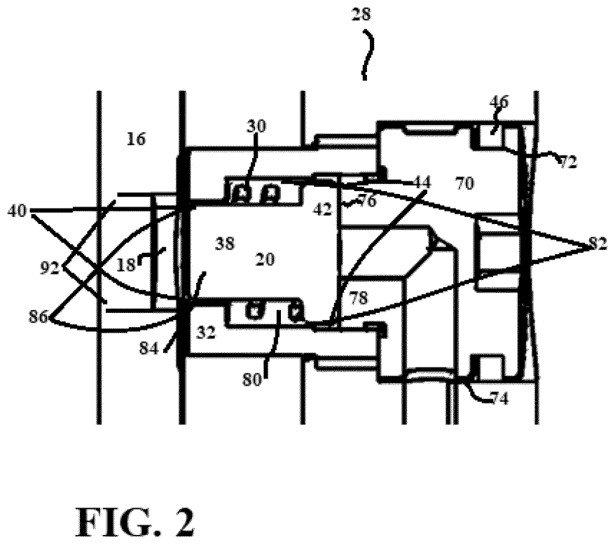

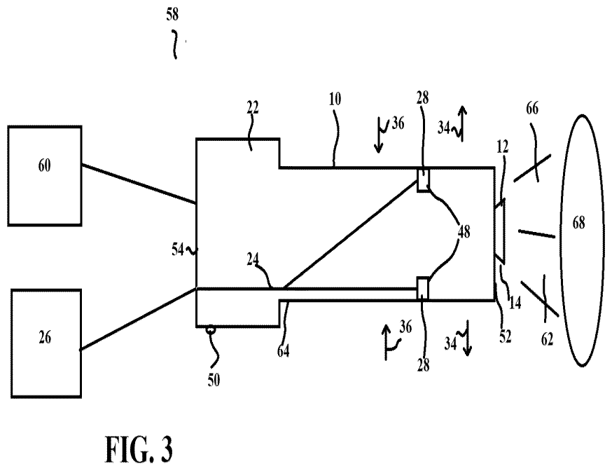

As shown in FIGS. 1-3, a rotary atomizer 10 can include an applicator 12 attached to a distal end 14 of a shaft 16, which can be a turbine shaft 16, wherein the shaft 16 can include at least one recess 18 configured to receive a locking pin 20. In some embodiments, the rotary atomizer 10 further can include a spindle 22 circumscribing the shaft 16, wherein the spindle 22 can include a compressed air line 24. In certain embodiments, the compressed air line 24, when actuated, supplies compressed air from a compressed air source 26 to at least one locking mechanism 28, and the compressed air line 24, when not actuated, does not supply compressed air to the at least one locking mechanism 28. In some embodiments, the rotary atomizer 10 can provide that the at least one locking mechanism 28 can be at least partially circumscribed by the spindle 22. In certain embodiments, the at least one locking mechanism 28 can be entirely circumscribed by the spindle 22. In certain embodiments, the at least one locking mechanism 28 can include a spring 30, wherein the spring 30 can be coupled to a locking pin shaft side 38 and the locking pin 20. In some embodiments, the rotary atomizer 10 can provide that the locking pin 20 can be prevented from engaging with the shaft 16 when the compressed air line 24 can be not actuated based on a spring force 34 provided by the spring 30. According to certain embodiments, the locking pin 20 can be located at least partially outside of the at least one locking mechanism 28 when the compressed air line 24 can be actuated, based on a compressed air force 36 exceeding the spring force 34. In some embodiments, the rotary atomizer 10 can provide that the locking pin 20 can include a locking pin shaft side 38 can include a shaft side diameter 40 and locking pin spindle side 42 can include a spindle side diameter 44, wherein the spindle side diameter 44 can be greater than the shaft side diameter 40. According to certain embodiments, the at least one locking mechanism 28 can include an o-ring seal 46 between the compressed air line 24 and a spindle 22 outer wall. In certain embodiments, the o-ring seal 46 can be configured to prevent compressed air from the compressed air line 24 from escaping the at least one locking mechanism 28 when the compressed air line 24 can be actuated. In some embodiments, the rotary atomizer 10 can provide that the at least one locking mechanism 28 can be two locking mechanisms 48. In certain embodiments, the spindle 22 can include a button 50, wherein actuation of the button 50 can be configured to actuate the compressed air line 24. In some embodiments, the rotary atomizer 10 can provide that the spindle 22 can include a spindle applicator end 52 and spindle supply end 54, and wherein the button 50 can be located closer to the spindle supply end 54 than the spindle applicator end 52. In certain embodiments, the at least one recess 18 can be two recesses 56.

A system 58 can include a coating 62 supply configured to supply a coating 62, a compressed air source 26, and a rotary atomizer 10 in fluid communication with the coating 62 source and the compressed air source 26, wherein the rotary atomizer 10 can include at least one locking mechanism 28. In some embodiments, the system 58 can provide that the rotary atomizer 10 can be an aerostatic, electrostatic atomizer 64. According to certain embodiments, the coating 62 can be a paint 66. According to certain embodiments, the system 58 further can include a target 68 to be coated with the coating 62 by the rotary atomizer 10.

A locking mechanism 28 for a rotatable shaft 16, can include a locking pin 20 can include a locking pin shaft side 38 and locking pin spindle side 42, a compressed air supply port 70 in fluid communication with a compressed air source 26, and a spring 30, wherein the spring 30 can be configured to place the locking pin spindle side 42 in direct mechanical communication with the compressed air supply port 70 when the compressed air supply can be not actuated. In some embodiments, the shaft 16 can include a shaft inner portion 94. According to certain embodiments, the compressed air supply port 70 can include a notch 72 circumscribing the compressed air supply port 70 and an o-ring seal 46 in the notch 72. In some embodiments, the locking mechanism 28 can provide that the o-ring seal 46 can be in direct adjacent contact with a spindle 22. According to certain embodiments, based on actuation of the compressed air supply, the o-ring seal 46 can be configured to prevent air from escaping the locking mechanism 28. In some embodiments, the locking mechanism 28 can provide that the compressed air supply port 70 can include a port supply side 74 and port exit side 76, wherein the port exit side 76 can be parallel with the locking pin spindle side 42, wherein the spindle 22 can include a spindle applicator end 52 and spindle supply end 54, and wherein the port supply side 74 can be parallel with the spindle supply end 54. According to certain embodiments, the spring 30 can be circumscribed by a locking pin shaft side 38, wherein the locking pin shaft side 38 can be radially between the compressed air supply line and the rotatable shaft 16. In some embodiments, the locking mechanism 28 can provide that the locking pin shaft side 38 circumscribes at least a portion 78 of the compressed air supply port 70. According to certain embodiments, the locking mechanism shaft side 32 defines an inner space 80 and that can include a first diameter 82 and an exit space 84 that can include a second diameter 86, wherein the first diameter 82 can be greater than the second diameter 86. In some embodiments, the locking mechanism 28 can provide that the locking pin shaft side 38 can include a shaft side diameter 40 and locking pin spindle side 42 can include a spindle side diameter 44, wherein the spindle side diameter 44 can be greater than the shaft side diameter 40. According to certain embodiments, the spring 30 can include a spring 30 diameter, wherein the spring 30 diameter can be less than the spindle side diameter 44, and wherein the spring 30 diameter can be greater than the shaft side diameter 40. According to certain embodiments, the spring 30 diameter can be less than first diameter 82, and wherein the spring 30 diameter can be greater than the second diameter 86. In some embodiments, the locking mechanism 28 can provide that the spindle side diameter 44 can be less than the first diameter 82, and wherein the spindle side diameter 44 can be greater than the second diameter 86. According to certain embodiments, the shaft side diameter 40 can be less than the second diameter 86.

A rotary atomizer 10 can include the locking mechanism 28 of the present embodiments and an applicator 12 attached to a distal end 14 of a shaft 16, wherein the shaft 16 can include at least one recess 18 configured to receive the locking pin shaft side 38 when the compressed air supply can be actuated. The rotary atomizer 10 further can include a second locking mechanism 28 of the present embodiments wherein the at least one recess 18 can be two recesses 56, and wherein the recess 18es comprise a recess diameter 92, and wherein the recess diameter 92 can be greater than the spindle side diameter 44, and wherein the recess diameter 92 can be less than the first diameter 82.

We claim:

1. A rotary atomizer comprising:
an applicator attached to a distal end of a shaft;
wherein the shaft comprises at least one recess configured to receive a locking pin.

2. The rotary atomizer of claim 1, further comprising a spindle circumscribing the shaft, wherein the spindle comprises a compressed air line.

3. The rotary atomizer of claim 2, wherein the compressed air line, when actuated, supplies compressed air from a compressed air source to at least one locking mechanism, and wherein the compressed air line, when not actuated, does not supply compressed air to the at least one locking mechanism.

4. The rotary atomizer of claim 3, wherein the at least one locking mechanism is located at least partially circumscribed by the spindle.

5. The rotary atomizer of claim 4, wherein the at least one locking mechanism is entirely circumscribed by the spindle.

6. The rotary atomizer of claim 4, wherein the at least one locking mechanism comprises a spring, wherein the spring is coupled to an inner wall of the spindle and the locking pin.

7. The rotary atomizer of claim 6, wherein the locking pin is prevented from engaging with the shaft when the compressed air line is not actuated based on a spring force provided by the spring.

8. The rotary atomizer of claim 7, wherein the locking pin is located at least partially outside of the at least one locking mechanism when the compressed air line is actuated, based on compressed air force exceeding the spring force.

9. The rotary atomizer of claim 8, wherein the locking pin comprises a locking pin shaft side comprising a shaft side diameter and locking pin spindle side comprising a spindle side diameter, wherein the spindle side diameter is greater than the shaft side diameter.

10. The rotary atomizer of claim 3, wherein the at least one locking mechanism comprises an o-ring seal between the compressed air line and a spindle outer wall.

11. The rotary atomizer of claim 10, wherein the o-ring seal is configured to prevent compressed air from the compressed air line from escaping the at least one locking mechanism when the compressed air line is actuated.

12. The rotary atomizer of claim 3, wherein the at least one locking mechanism is two locking mechanisms.

13. The rotary atomizer of claim 2, wherein the spindle comprises a button, wherein actuation of the button is configured to actuate the compressed air line.

14. The rotary atomizer of claim 13, wherein the spindle comprises a spindle applicator end and spindle supply end, and wherein the button is located closer to the spindle supply end than the spindle applicator end.

15. The rotary atomizer of claim 1, wherein the at least one recess is two recesses.
